(19) United States
(12) Patent Application Publication
(10) Pub. No.: US 2024/0333909 A1
(43) Pub. Date: Oct. 3, 2024

(54) METHODS AND APPARATUS FOR MONITORING WIFI CAMERAS

(71) Applicant: Panasonic Automotive Systems Company of America, Division of Panasonic Corporation of North America, PEACHTREE CITY, GA (US)

(72) Inventors: JANARDHAN THODETI, PEACHTREE CITY, GA (US); BARRY MARTIN, PEACHTREE CITY, GA (US); WALTER VARDA, NEWNAN, GA (US); XIANCHAO YANG, PEACHTREE CITY, GA (US)

(21) Appl. No.: 18/743,200

(22) Filed: Jun. 14, 2024

Related U.S. Application Data
(62) Division of application No. 18/382,194, filed on Oct. 20, 2023.
Application No. 18/382,194 is a division of application No. 17/695,664, filed on Mar. 15, 2022, now abandoned.
(60) Provisional application No. 63/193,988, filed on May 27, 2021.

(51) Int. Cl. H04N 17/00; H04N 7/18; H04N 23/52; H04N 23/65

(52) U.S. Cl. CPC H04N 17/002; H04N 7/183; H04N 23/52; H04N 23/651

(57) ABSTRACT

A Wi-Fi camera includes an accelerometer and detects mechanical shock events. An electronic processor is communicatively coupled to the accelerometer and produces a record of the shock events detected by the accelerometer. The electronic processor performs shock monitoring while the camera is in low power and sleep modes. A system-on-chip performs shock monitoring while the camera is in full operation, standby and idle modes.

### CROSS-REFERENCED TO RELATED APPLICATIONS

This application is a divisional of U.S. patent application Ser. No. 18/382,194, filed on Oct. 20, 2023, which claims benefit of U.S. patent application Ser. No. 17/695,664, filed on Mar. 15, 2022, which claims benefit of U.S. Provisional Application No. 63/193,988, filed on May 27, 2021, the disclosures of which are hereby incorporated by reference in their entireties for all purposes.

### BACKGROUND OF THE INVENTION

### 1. Field of the Invention

The present invention relates to a shock monitoring system for a WiFi camera; freeze frame detection for a WiFi camera; video streaming wirelessly over long distances with low latency; WiFi camera pairing; humidity monitoring in a WiFi camera; and wireless IP camera low power operation.

### 2. Description of the Related Art

Wireless IP camera freeze frame detection with an in-vehicle infotainment system is unavailable. Wireless IP cameras for automotive and real-time video applications need a way to notify a user about stale video data or delayed video.

Another problem is that the available video stream bandwidth decreases over long distances. Low latency video streaming wirelessly over long distances is unavailable for automotive use-cases. Video streaming wirelessly for automotive use-cases is available but these does not support low latency and long distances necessary for trailer applications.

### SUMMARY OF THE INVENTION

The present invention provides a method and apparatus for shock monitoring a WiFi camera for potential warranty issues. A log, timestamp and shock event may be recorded to mitigate potential warranty claims. With a record of shock events, any warranty claims may be voided based on the user mishandling the WiFi camera.

The present invention provides a method and apparatus for freeze frame detection on WiFi camera. A video buffer from a lens to digital signal processor and WiFi output is compared with a previous frame for 30 frames and triggers a notification to the user via video overlay or a message communication over WiFi/Bluetooth. Freeze frame detection can be implemented on in-vehicle infotainment system with less accuracy.

The present invention provides a method and apparatus for video streaming wirelessly over long distances with low latency for automotive and trailer applications. The invention may provide low latency video streaming wirelessly over long distances for automotive in vehicle infotainment display units. The inventive camera system automatically adjusts the video stream resolution and frame rate accordingly for a low latency video stream.

The present invention provides a method and apparatus for connecting a wireless internet protocol (IP) camera with an in-vehicle infotainment system using a smartphone application and QR code display on the infotainment system.

The present invention provides a method and apparatus for humidity monitoring WiFi camera seal integrity. A log, timestamp and humidity leak event may be recorded, and the customer may be notified via a video signal receiver. Thus, damage to the WiFi camera internals may be mitigated.

The present invention provides a method and apparatus for wireless IP camera low power operation for sustaining on low energy for long duration. A wireless IP camera operating on battery power needs to conserve energy while not video streaming in order to sustain long duration before a battery recharge is required. While not video streaming, the wireless IP camera may shut down the main microprocessor, peripherals and high-power antennas to conserve energy and enable only Bluetooth low energy on a low power antenna for command and control.

It is possible to suspend video streaming and have the main microprocessor available for command and control. However, this method consumes more energy and requires the battery to be recharged more frequently.

The invention comprises, in one form thereof, a WiFi camera including an accelerometer and detecting mechanical shock events. An electronic processor is communicatively coupled to the accelerometer and produces a record of the shock events detected by the accelerometer.

The invention comprises, in another form thereof, a method for detecting a freeze frame condition in a WiFi camera. The WiFi camera is used to capture a plurality of images, compare one of the images to another one of the images, and detect the freeze frame condition as a result of determining that a level of similarity between the two captured images exceeds a threshold level.

The invention comprises, in yet another form thereof, a camera system automatically adjusting a video stream resolution and frame rate accordingly for a low latency video stream.

The invention comprises, in still another form thereof, a WiFi Camera Pairing Method including presenting a motor vehicle's receiver information on the vehicle's display screen. A Wi-Fi camera is used to directly scan the vehicle's receiver information on the vehicle's display screen.

The invention comprises, in a further form thereof, a WiFi camera including a humidity sensor detecting humidity levels. An electronic processor is communicatively coupled to the humidity sensor and produces a record of the humidity levels detected by the humidity sensor. A user is notified in response to the detected humidity levels exceeding a threshold.

The invention comprises, in another form thereof, a wireless IP camera that, in a non-video streaming mode, shuts down a main microprocessor, peripherals and high-power antennas to conserve energy and enable only Bluetooth low energy on a low power antenna for command and control.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a shock monitoring WiFi camera of the present invention.

FIG. 2 is a block diagram of one embodiment of a WiFi camera freeze frame detection arrangement of the present invention.

FIG. 3 is a schematic diagram of a Trailer Camera Coverage Area Experience Whip Antenna with Cab according to one embodiment of the invention.

FIG. 4 is a schematic diagram of a Trailer Camera Coverage Area Experience Dual Sharkfin Antenna according to one embodiment of the invention.

FIG. 5 is photographs illustrating a Trailer Camera Coverage Area Experience Dual Sharkfin Antenna according to one embodiment of the invention.

FIG. 6 is a schematic illustration of one embodiment of a WiFi Camera Pairing Method of the present invention.

FIG. 7 is a block diagram of one embodiment of a humidity monitoring seal integrity WiFi camera of the present invention.

FIG. 8 illustrates WiFi Camera Modes of Operation according to one embodiment of the present invention.

FIG. 9 is a flow chart of one embodiment of a method of the present invention for detecting a freeze frame condition in a WiFi camera.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

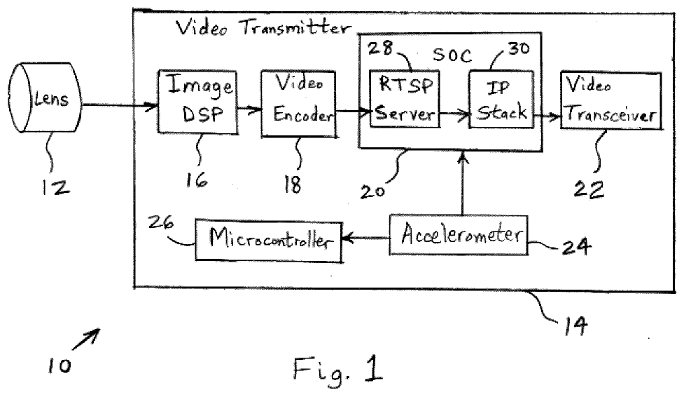

FIG. 1 illustrates one embodiment of a shock monitoring WiFi camera 10 of the present invention including a lens 12 and a video transmitter 14. Video transmitter 14 includes an image digital signal processor 16, a video encoder 18, a systems-on-chip 20, a video transceiver 22, an accelerometer 24, and a microcontroller 26. Systems-on-chip 20 includes a real time streaming protocol server 28 and an internet protocol stack 30.

During use, systems-on-chip 20 performs shock monitoring while camera 10 is in full operation, standby and idle modes. Microcontroller 26 performs shock monitoring while camera 10 is in low power and sleep modes.

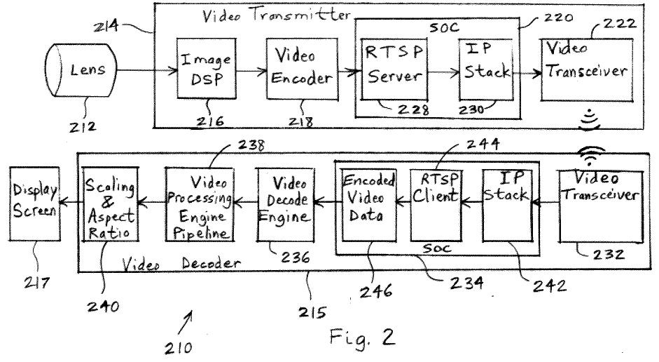

FIG. 2 illustrates one embodiment of a WiFi camera freeze frame detection arrangement 210 of the present invention, including a lens 212, a video transmitter 214, a video decoder 215, and a display screen 217. Video transmitter 214 includes an image digital signal processor 216, a video encoder 218, a systems-on-chip 220, and a video transceiver 222. Systems-on-chip 220 includes a real time streaming protocol server 228 and an internet protocol stack 230. Video decoder 215 includes a video transceiver 232, a systems-on-chip 234, a video decode engine 236, a video processing engine pipeline 238, and a scaling and aspect ratio block 240. Systems-on-chip 234 includes an internet protocol stack 242, a real time streaming protocol client 244, and an encoded video data block 246. Freeze frame detection by comparing with a previous video frame primarily involves lens 212, image digital signal processor 216, video encoder 218, video decode engine 236, video processing engine pipeline 238, and display screen 217.

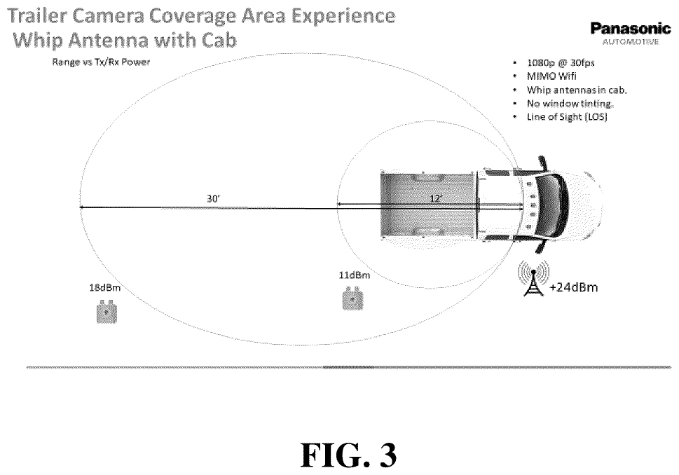

FIG. 3 illustrates a Trailer Camera Coverage Area Experience Whip Antenna with Cab according to one embodiment of the invention.

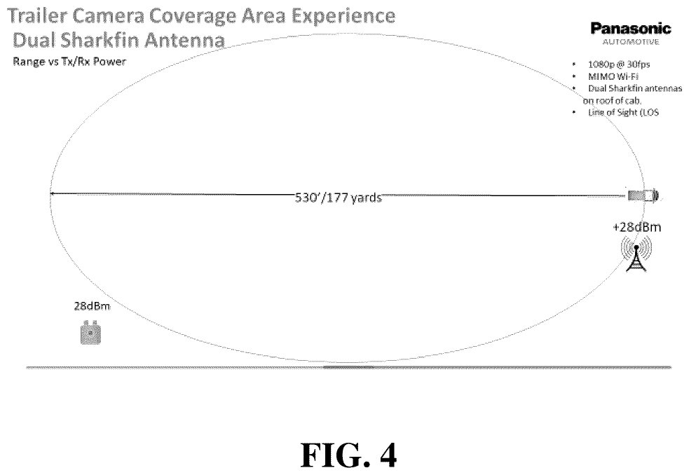

FIG. 4 illustrates a Trailer Camera Coverage Area Experience Dual Sharkfin Antenna according to one embodiment of the invention.

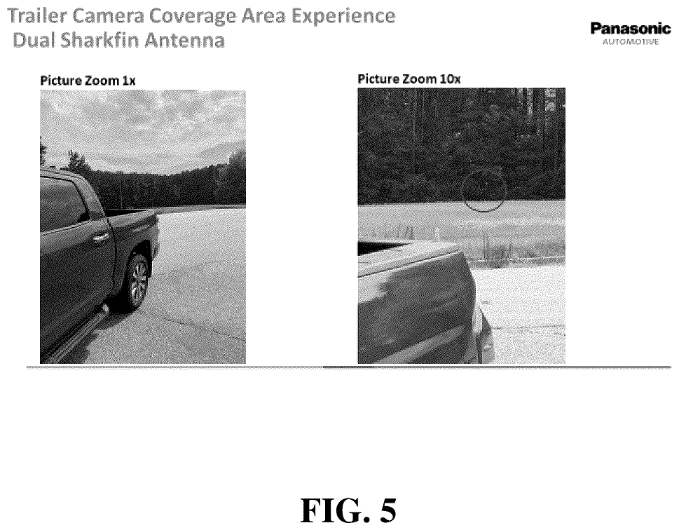

FIG. 5 includes two photographs illustrating a Trailer Camera Coverage Area Experience Dual Sharkfin Antenna according to one embodiment of the invention.

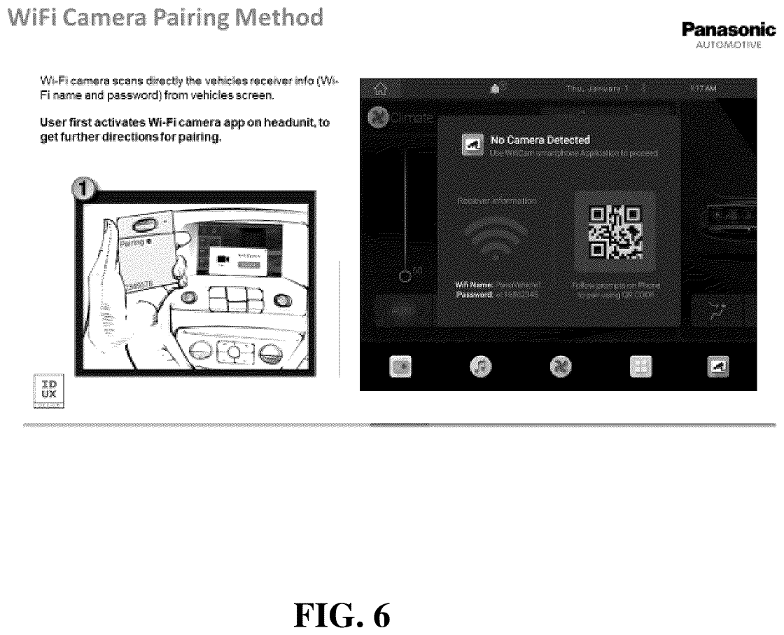

FIG. 6 illustrates of one embodiment of a WiFi Camera Pairing Method of the present invention. A Wi-Fi camera scans directly the vehicle's receiver information (e.g., WiFi name and password) from the vehicle's display screen. The user first activates a Wi-Fi camera app on a head unit in order to get further directions for pairing.

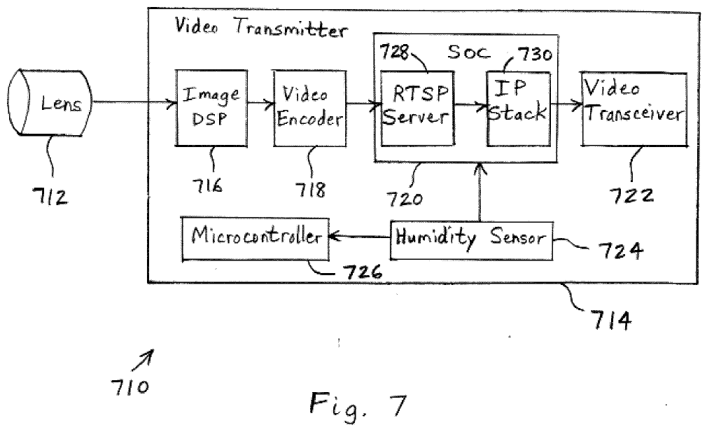

FIG. 7 illustrates one embodiment of a humidity monitoring seal integrity WiFi camera 710 of the present invention including a lens 712 and a video transmitter 714. Video transmitter 714 includes an image digital signal processor 716, a video encoder 718, a systems-on-chip 720, a video transceiver 722, a humidity sensor 724, and a microcontroller 726. Systems-on-chip 720 includes a real time streaming protocol server 728 and an internet protocol stack 730.

During use, systems-on-chip 720 performs humidity monitoring while camera 10 is in full operation, standby and idle modes. Microcontroller 26 performs humidity monitoring while camera 10 is in low power and sleep modes.

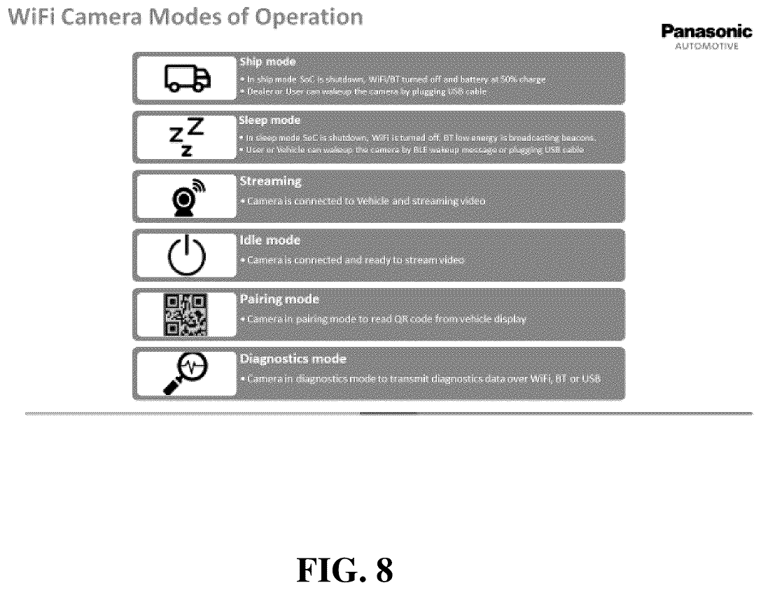

FIG. 8 illustrates WiFi Camera Modes of Operation according to one embodiment of the present invention. In ship mode, the systems-on-chip is shut down, the WiFi/Bluetooth is turned off, and the battery is at 50% charge. The dealer or user can wake up the camera by plugging in a USB cable.

In sleep mode, the systems-on-chip is shut down, WiFi is turned off. Bluetooth broadcasts beacons at low energy. The user or vehicle can wake up the camera by Bluetooth low energy (BLE) wakeup message or plugging in a USB cable.

In streaming mode, the camera is connected to the vehicle and streams video.

In idle mode, the camera is connected and is ready to stream video.

In pairing mode, the camera reads a QR code from a vehicle display.

In diagnostics mode, the camera transmits diagnostics data over WiFi, Bluetooth or USB.

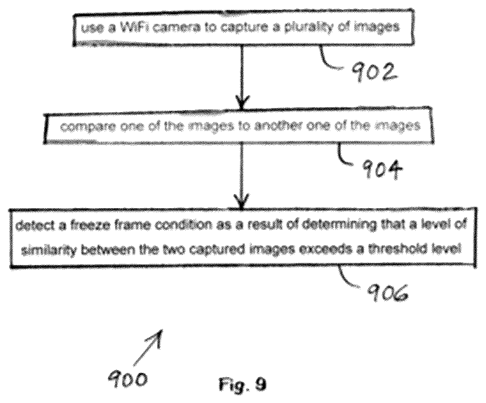

FIG. 9 illustrates one embodiment of a method 900 of the present invention for detecting a freeze frame condition in a WiFi camera. In a first step 902, a WiFi camera is used to capture a plurality of images. For example, a camera including lens 212, a video transmitter 214, and a video decoder 215 may capture a plurality of images.

Next, in step 904, one of the images is compared to another one of the images. For example, a video buffer from a lens to digital signal processor and WiFi output may be compared with a previous frame for 30 frames.

In a final step 906, the freeze frame condition is detected as a result of determining that a level of similarity between the two captured images exceeds a threshold level. For example, if a pixel-to-pixel comparison of the two images shows that more than a threshold number or percentage of pixels are identical in the two images, then it may be determined that there is a freeze frame condition.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A WiFi camera, comprising:
an accelerometer configured to detect mechanical shock events; and
an electronic processor communicatively coupled to the accelerometer and configured to produce a record of the shock events detected by the accelerometer.

2. The camera of claim 1 wherein the electronic processor is configured to perform shock monitoring while the camera is in low power and sleep modes.

3. The camera of claim 2 further comprising a system-on-chip communicatively coupled to the accelerometer and configured to perform shock monitoring while the camera is in full operation, standby and idle modes.

4. The camera of claim 3 wherein the system-on-chip includes a real time streaming protocol server and an internet protocol stack.

5. The camera of claim 1 wherein the record of the shock events detected by the accelerometer includes a timestamp associated with each of the shock events.

6. The camera of claim 1 further comprising a system-on-chip communicatively coupled to the accelerometer and configured to perform shock monitoring while the camera is in full operation, standby and idle modes.

7. The camera of claim 1 further comprising a system-on-chip communicatively coupled to the accelerometer and configured to perform shock monitoring when the electronic processor is not performing shock monitoring.

8. A WiFi camera, comprising:
an accelerometer configured to detect mechanical shock events experienced by the camera; and
an electronic processor communicatively coupled to the accelerometer and configured to produce a record of the shock events detected by the accelerometer.

9. The camera of claim 8 wherein the electronic processor is configured to perform shock monitoring while the camera is in low power and sleep modes.

10. The camera of claim 9 further comprising a system-on-chip communicatively coupled to the accelerometer and configured to perform shock monitoring while the camera is in full operation, standby and idle modes.

11. The camera of claim 10 wherein the system-on-chip includes a real time streaming protocol server and an internet protocol stack.

12. The camera of claim 8 wherein the record of the shock events detected by the accelerometer includes a timestamp associated with each of the shock events.

13. The camera of claim 8 further comprising a system-on-chip communicatively coupled to the accelerometer and configured to perform shock monitoring while the camera is in full operation, standby and idle modes.

14. The camera of claim 8 further comprising a system-on-chip communicatively coupled to the accelerometer and configured to perform shock monitoring when the electronic processor is not performing shock monitoring.

15. A camera, comprising:
an accelerometer configured to detect mechanical shock events experienced by the camera; and
an electronic processor communicatively coupled to the accelerometer and configured to produce a record of the shock events detected by the accelerometer, the record being accessible by a party providing a warranty for the camera.

16. The camera of claim 15 wherein the electronic processor is configured to perform shock monitoring while the camera is in low power and sleep modes.

17. The camera of claim 16 further comprising a system-on-chip communicatively coupled to the accelerometer and configured to perform shock monitoring while the camera is in full operation, standby and idle modes, the system-on-chip including a real time streaming protocol server and an internet protocol stack.

18. The camera of claim 15 wherein the record of the shock events detected by the accelerometer includes a timestamp associated with each of the shock events.

19. The camera of claim 15 further comprising a system-on-chip communicatively coupled to the accelerometer and configured to perform shock monitoring while the camera is in full operation, standby and idle modes.

20. The camera of claim 15 further comprising a system-on-chip communicatively coupled to the accelerometer and configured to perform shock monitoring when the electronic processor is not performing shock monitoring.
